(19) United States
(12) Patent Application Publication
(10) Pub. No.: US 2025/0353064 A1
(43) Pub. Date: Nov. 20, 2025

(54) HEALTH ASSESSMENT METHOD FOR STAMPING MACHINE AND STAMPING MACHINE

(71) Applicant: Aktiebolaget SKF

(72) Inventors: Kai ZHANG, Shanghai (CN); Kaihuan ZHANG, Hanzhou (CN); Xiancheng DAI, Chengdu (CN)

(21) Appl. No.: 19/204,782

(22) Filed: May 12, 2025

(30) Foreign Application Priority Data
May 14, 2024 (CN) 202410598309.9

(51) Int. Cl. B21C 51/00; B21D 22/02

(52) U.S. Cl. CPC B21C 51/00; B21D 22/02

(57) ABSTRACT

A health assessment method of a stamping machine and that stamping machine are disclosed. The method includes obtaining vibration data of a bearing of the stamping machine, obtaining the rotational speed data of the bearing of the stamping machine, and based on the vibration data and the rotational speed data of the bearing of the stamping machine, performing the health assessment on the bearing of the stamping machine. According to the health assessment method of the stamping machine disclosed, accurate and timely health assessment of the stamping machine can be performed locally.

### CROSS-REFERENCE TO RELATED APPLICATION

This application is based on and claims priority to Chinese Patent Application No. 202410598309.9, filed on May 14, 2024 in the Chinese Patent Office, the entirety of which is hereby incorporated by reference.

### FIELD

The disclosure relates to machining equipment, in particular to a health assessment method for a stamping machine and the stamping machine.

### BACKGROUND

Stamping machine, also known as stamping machine and die forging press, is a machine that uses pressure to deform the processed material and punch it into various required structures. The functions of stamping machines include punching and shearing, metal material forming, deep drawing and metal forging. Stamping machines are generally used in conjunction with molds and are important equipment for producing metal mechanical parts. Stamping machines can include motors, bearings, driving systems, sliders, etc.

Stamping machine is the key manufacturing equipment in the production of mechanical equipment such as automobiles. The bearing failure of stamping machine will cause production interruption and huge economic losses. At present, in order to maintain the healthy operation of stamping machines, maintenance engineers can evaluate mechanical equipment failures by measuring relevant data when the stamping machines are stopped. However, depending on the qualifications of maintenance engineers, there is great uncertainty in evaluating stamping machines through maintenance engineers. Traditional regular manual maintenance consumes a lot of manpower and cost, and can't find faults in time and accurately.

In addition, due to data security issues, the stamping machine owner may not want to upload the processing data of the stamping machine to the server or the cloud.

Therefore, a method that can evaluate the health of stamping machines locally is expected.

### SUMMARY

The embodiment of the disclosure discloses a health assessment method for a stamping machine, comprising: obtaining vibration data of a bearing of the stamping machine, obtaining the rotational speed data of the bearing of the stamping machine, and based on the vibration data and the rotational speed data of the bearing of the stamping machine, performing the health assessment on the bearing of the stamping machine.

The method according to the embodiment of the disclosure, wherein, obtaining the vibration data of the bearing of the stamping machine through the vibration sensor installed at the support of the bearing of the stamping machine, obtaining the rotational speed data of the bearing of the stamping machine through the tachometer installed at the support of the bearing of the stamping machine.

The method according to the embodiment of the disclosure, further comprising: extracting valid data from the vibration data and the rotational speed data, wherein the valid data extraction comprises: obtaining vibration data and rotational speed data of a target working condition in a plurality of working conditions.

The method according to the embodiment of the disclosure, wherein the plurality of working conditions correspond to different processing speed ranges of the stamping machine.

The method according to the embodiment of the disclosure, wherein the valid data extraction further comprises: filtering external disturbance signals from vibration data and rotational speed data of a target working condition to obtain filtered vibration data and filtered rotational speed data, wherein the external disturbance signals comprise stamping signals in machining process of the stamping machine, removing outliers from the filtered vibration data and the filtered rotational speed data.

The method according to the embodiment of the disclosure, wherein the vibration data comprises acceleration data, and performing the health assessment of the bearing of the stamping machine based on the vibration data and the rotational speed data comprises: obtaining one or more of frequency spectrum data of acceleration data, velocity data and frequency spectrum data of velocity data, envelope data of acceleration and frequency spectrum data of envelope data of acceleration by data conversion of vibration data.

The method according to the embodiment of the disclosure, wherein performing the health assessment of the bearing of the stamping machine based on the vibration data and the rotational speed data further comprises: obtaining one or more of bearing rotation frequency and its harmonics, gear meshing frequency and its harmonics, bearing failure frequency and its harmonics by feature extraction of acceleration data, frequency spectrum data of acceleration data, velocity data and frequency spectrum data of velocity data, envelope data of acceleration and frequency spectrum data of envelope data of acceleration.

The method according to the embodiment of the disclosure, wherein performing the health assessment of the bearing of the stamping machine based on the vibration data and the rotation speed data comprises performing the health assessment of the bearing of the stamping machine through the trained abnormality detection model and the trained fault diagnosis model, wherein the trained anomaly detection model is configured to determine whether a fault occurs in the stamping machine, wherein, the trained fault diagnosis model is configured to determine the types of faults occurring in the stamping machine.

The method according to the embodiment of the disclosure, further comprises: downloading a general anomaly detection model from a server, training the general anomaly detection model locally to obtain the trained anomaly detection model, download the general fault diagnosis model from the server and train the general fault diagnosis model locally to obtain the trained fault diagnosis model.

The embodiment of the disclosure discloses a stamping machine comprising: a bearing configured to support the transmission mechanism to transmit power from the motor to the slider through the transmission mechanism, so that the slider performs a stamping action, a vibration sensor installed at a support of the bearing and configured to obtain vibration data of the bearing, a tachometer installed at the support of the bearing and configured to obtain rotational speed data of the bearing, a processor, coupled to the vibration sensor and the tachometer, and executing the program code stored in the memory to perform the health assessment on the bearing of the stamping machine based on the vibration data and the rotational speed data of the bearing of the stamping machine.

The embodiment of the disclosure discloses a health assessment apparatus for a stamping machine, which comprises a vibration sensor installed at a bearing support of the stamping machine and configured to obtain vibration data of the bearing of the stamping machine, a tachometer installed at the bearing support of the stamping machine and configured to obtain rotation data of the bearing of the stamping machine, and a processor coupled to the vibration sensor and the tachometer and configured to conduct health assessment on the bearing of the stamping machine based on the vibration data and the rotation data.

The embodiment of the disclosure discloses a health assessment system for a stamping machine, which comprises a server configured to store a general abnormality detection model and a general fault diagnosis model, and a stamping machine health assessment apparatus comprising a vibration sensor installed at a bearing support of the stamping machine and configured to obtain vibration data of the bearing of the stamping machine, a tachometer installed at the bearing support of the stamping machine, a processor, coupled to the vibration sensor and the tachometer, is configured to download a general anomaly detection model and a general fault diagnosis model from a server, locally train the general anomaly detection model and the general fault diagnosis model to obtain a trained anomaly detection model and a trained fault diagnosis model, and perform health assessment on the stamping machine bearing based on the vibration data and the rotation speed data through the trained anomaly detection model and the trained fault diagnosis model.

Embodiments of the present disclosure disclose one or more non-transitory storage media having stored thereon instructions that, when executed by a processor, cause the processor to perform the method as described above.

According to the health assessment method, the stamping machine, the stamping machine health assessment apparatus, the stamping machine health assessment system and the storage medium of the embodiment of the present disclosure, accurate and timely health assessment of the stamping machine can be performed locally based on vibration data and rotational speed data of bearings. Through real-time or near-real-time health assessment of stamping machines, the performance degradation or failure of stamping machines can be found in time, thus reducing the probability of unexpected shutdown and potential losses. By preprocessing vibration data and rotational speed data, more accurate and valid data can be obtained, which makes the health assessment of stamping machines more accurate. The machine learning model downloaded locally is used to evaluate the health of the stamping machine, and the processing data of the stamping machine does not need to be uploaded to the server or the cloud, so the data security is guaranteed.

### BRIEF DESCRIPTION OF DRAWINGS

The above and other aspects, features and advantages of specific embodiments of the present disclosure will become more apparent from the following description taken in conjunction with the accompanying drawings, in which:

FIG. 1 is an exemplary flowchart of a health assessment method for a stamping machine according to an embodiment of the present disclosure,

FIG. 2 is an example flow chart of another health assessment method for a stamping machine according to an embodiment of the present disclosure,

FIG. 3A is an example graph of vibration data of a target working condition including an external disturbance signal,

FIG. 3B is an example graph of filtered vibration data that filters out external disturbance signals from vibration data of a target working condition,

FIG. 4 is an exemplary diagram of removing outliers from filtered vibration data according to an embodiment of the present disclosure,

FIG. 5 is an exemplary schematic diagram of a generated health assessment score according to an embodiment of the present disclosure,

FIG. 6 is an exemplary schematic diagram of a stamping machine according to an embodiment of the present disclosure,

FIG. 7 is an exemplary schematic diagram of a health assessment device for a stamping machine according to an embodiment of the present disclosure, and

FIG. 8 is an exemplary schematic diagram of a health assessment system of a stamping machine according to an embodiment of the present disclosure.

### DETAILED DESCRIPTION

Before proceeding to the following detailed description, it may be beneficial to set forth the definitions of certain words and phrases used throughout this patent application document. The terms “including” and “containing” and their derivatives refer to including but not limited to. The term “controller” or “control unit” refers to any device, system or part thereof that controls at least one operation. Such a controller may be implemented in hardware or a combination of hardware and software and/or firmware. The functions associated with any particular controller can be centralized or distributed, whether local or remote. The phrase “at least one”, when used with a list of items, means that different combinations of one or more of the listed items can be used, and only one item in the list may be needed. For example, “at least one of a, b and c” includes any one of the following combinations: a, b, c, a and b, a and c, b and c, a and b and c.

Definitions of other specific words and phrases are provided throughout this patent application document. It should be understood by those skilled in the art that in many cases, if not most cases, this definition also applies to the previous and future uses of words and phrases so defined.

The following description of various embodiments of the principles of the present disclosure in this patent application document with reference to the accompanying drawings is for illustration only and should not be interpreted as limiting the scope of the present disclosure in any way. Those skilled in the art will understand that the principles of the present disclosure can be implemented in any suitably arranged system or device. In some cases, the actions described in the specification can be performed in a different order and still achieve the desired results. Moreover, the processes depicted in the drawings do not necessarily require the specific order shown or sequential order to achieve the desired results. In certain embodiments, multitasking and parallel processing may be advantageous.

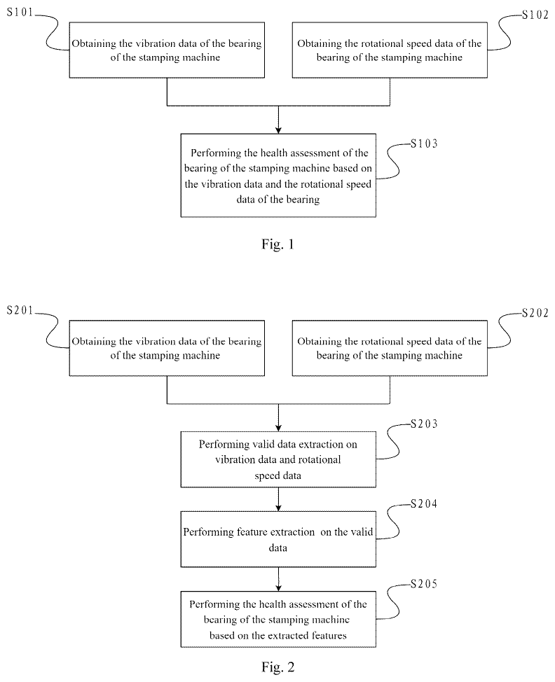

FIG. 1 is an exemplary flowchart of a health assessment method for a stamping machine according to an embodiment of the present disclosure.

At step S101, the vibration data of the bearing of the stamping machine can be obtained. For example, the vibration data of the bearing of the stamping machine can be obtained by the vibration sensor. The vibration data may include acceleration data and the like.

Vibration sensors may include, but are not limited to, mechanical vibration sensors, optical vibration sensors, and electrical vibration sensors (such as inductive vibration sensors, eddy current vibration sensors, capacitive vibration sensors, resistance strain vibration sensors, and piezoelectric vibration sensors). In one embodiment, the vibration sensor may be installed at the support of the bearing of the stamping machine.

At step S102, the rotational speed data of the bearing of the stamping machine can be obtained. For example, the rotational speed data of the bearing of the stamping machine can be obtained by the tachometer.

The tachometer can include, but is not limited to, centrifugal tachometer, magnetic tachometer, electric tachometer, magnetoelectric tachometer and flash tachometer. In one embodiment, the tachometer may be installed at the support of the bearing of the stamping machine.

In S103, the health assessment of the bearing of the stamping machine can be performed based on the vibration data and the rotational speed data of the bearing. For example, the health assessment of the bearing of the stamping machine can be performed based on the vibration data and the rotational speed data of the bearing of the stamping machine to output a score indicating the health degree of the bearing of the stamping machine.

FIG. 2 is an example flow chart of another health assessment method of a stamping machine according to an embodiment of the present disclosure.

At step S201, the vibration data of the bearing of the stamping machine can be obtained. For example, the vibration data of the bearing of the stamping machine is obtained by a vibration sensor installed at the support of the bearing of the stamping machine. The vibration data may include acceleration data and the like.

At step S202, the rotational speed data of the bearing of the stamping machine can be obtained. For example, the rotational speed data of the bearing of the stamping machine is obtained by a tachometer installed at the support of the bearing of the stamping machine.

At step S203, valid data extraction can be performed on vibration data and rotational speed data. Valid data extraction can include obtaining vibration data and rotational speed data of a target working condition among a plurality of working conditions, filtering out external disturbance signals from the vibration data and rotational speed data of the target working condition, and removing outliers from the filtered vibration data and the filtered rotational speed data.

Valid data extraction may include obtaining vibration data and rotational speed data of a target working condition among a plurality of working conditions. For example, the obtained vibration data and rotational speed data can be data under various working conditions. A variety of different working conditions can include debugging working conditions and normal processing working conditions. The data of normal processing working conditions can be extracted from the obtained vibration data and rotational speed data. Normal processing working conditions can include a variety of specific processing working conditions, for example, various specific processing working conditions can correspond to different machining speeds (for example, the speed of stamping by a stamping machine), or can correspond to different machined workpieces. The vibration data and rotational speed data of the target working condition among multiple working conditions can be obtained. The target working condition may be a normal working condition or one or more of a plurality of specific working conditions.

In one embodiment, the target operating condition can be identified by the rotational speed data. Machining conditions can be identified based on the rotating speed of the bearing of the stamping machine. For example, a faster bearing rotating speed corresponds to a faster machining speed. The working condition of the stamping machine is determined based on the rotating speed range in which the rotating speed of the bearing falls. In another embodiment, the working condition of the stamping machine can be determined based on the scheduling data stored in the stamping machine. For example, the scheduling data stored in the stamping machine can be called to determine the machining speed of the stamping machine or the workpiece to be machined, so as to determine the working condition of the stamping machine.

Valid data extraction can include filtering out external disturbance signals from vibration data and rotational speed data of the target working condition. External disturbance signals can be filtered from the vibration data and rotational speed data of the target working condition to obtain filtered vibration data and filtered rotational speed data. The external disturbance signal may mainly include the stamping signal in the machining process of the stamping machine. The external disturbance signal may also include the vibration signal generated by the relevant components of the stamping machine due to the processing signal of the stamping machine. In one embodiment, the external disturbance signal can be filtered out from the vibration data and rotational speed data of the target working condition through the sliding window algorithm.

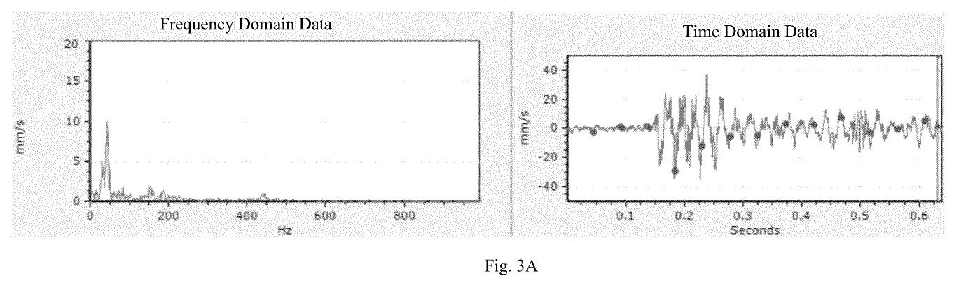

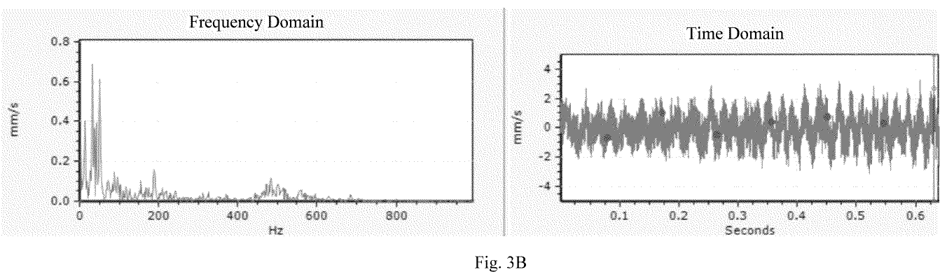

FIG. 3A is an example diagram of vibration data of a target working condition including an external disturbance signal. FIG. 3B is an example diagram of filtered vibration data that filters out external disturbance signals from vibration data of a target operating condition.

With reference to FIGS. 3A and 3B, an example of filtering out external disturbance signals from vibration data of a target working condition will be described. As shown in FIG. 3A, in the frequency domain data containing vibration data of external disturbance signals, the highest amplitude of vibration data is about 10 mm/s, and the highest amplitude of vibration data appears at a frequency of about 40 Hz; in the time domain data of vibration data containing external disturbance signals, the highest amplitude of vibration data is about 38 mm/s. As shown in FIG. 3B, among the frequency domain data of the filtered vibration data from which the external disturbance signal is filtered, the highest amplitude of the vibration data is about 0.68 mm/s, and the highest amplitude of the vibration data appears at a frequency of about 30 Hz, and the distribution of the frequency domain data of the filtered vibration data from which the external disturbance signal is filtered is obviously different from that of the frequency domain data containing the external disturbance signal; in the time domain data of filtered vibration data from which the external disturbance signal is filtered, the maximum amplitude of vibration data is about 3 mm/s. By filtering the larger external disturbance signal from the vibration data of the target working condition, more accurate vibration data of the bearing can be obtained for subsequent analysis. Although FIGS. 3A and 3B only show examples of vibration data, those skilled in the art can understand that similar effects can be obtained by filtering out external disturbance signals from the rotational speed data of the target working condition.

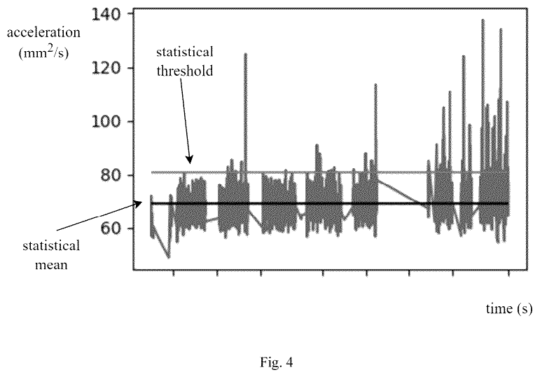

FIG. 4 is an exemplary diagram of removing outliers from filtered vibration data according to an embodiment of the present disclosure.

As shown in FIG. 4, the statistical threshold and statistical mean of vibration data can be determined. Values higher than the statistical threshold can be determined as outliers. By removing outliers from the vibration data, more accurate vibration data of bearings can be obtained for subsequent analysis. FIG. 4 shows the statistical threshold as the upper limit, and another statistical threshold as the lower limit can be set according to actual needs. Although FIG. 4 only shows an example of vibration data, those skilled in the art can understand that similar effects can be obtained by removing outliers from filtered rotational speed data.

Referring back to FIG. 2, at step S204, feature extraction can be performed on the valid data. Data conversion and feature extraction can be performed on the valid data, so as to obtain the features of the valid data for the training of machine learning models or the health assessment of bearings.

Data conversion can be performed on valid data. For example, the vibration data may include acceleration data of vibration. Vibration data including acceleration data can be converted to obtain velocity data of vibration and envelope data of acceleration. The acceleration data of vibration, the velocity data of vibration and the envelope data of acceleration can be further converted to obtain the spectrum data of acceleration data, the spectrum data of velocity data and the spectrum data of envelope data of acceleration.

Feature extraction can be performed on the valid data after data conversion. For example, feature extraction can be performed on acceleration data, frequency spectrum data of acceleration data, speed data, frequency spectrum data of speed data, envelope data of acceleration, frequency spectrum data of acceleration envelope data and rotation speed data, so as to obtain one or more of bearing rotation frequency and its harmonics, gear meshing frequency and its harmonics, bearing failure frequency and its harmonics. For example, the rotational frequency and its harmonics of the bearing of a stamping machine can be obtained based on the rotational speed data. The gear meshing frequency and its harmonics of the gear in contact with the bearing can be obtained by feature extraction of the converted data. The bearing fault frequency and its harmonics can represent the vibration frequency and its harmonics of the corresponding components in the bearing, and the change of the vibration frequency and its harmonics of the corresponding components in the bearing can be related to the bearing fault. For example, bearing fault frequency and its harmonics may include ball pass frequency inner BPFI and its harmonics, ball pass frequency outer BPFO and its harmonics, ball spin frequency BSF and its harmonics, fundamental train frequency FTF and its harmonics, etc. The change of ball pass frequency inner BPFI and its harmonics can be related to the failure of inner ring of bearing. The change of ball pass frequency outer BPFO and its harmonics can be related to the failure of bearing outer ring. The change of ball spin frequency BSF and its harmonics can be related to the failure of the ball of the bearing. The change of fundamental train frequency FTF and its harmonics can be related to the failure of bearing cage.

At step S205, the health assessment of the bearing of the stamping machine can be performed based on the extracted features. For example, the bearing health assessment of stamping machines can be performed based on machine learning model. A machine learning model can be trained based on the extracted features. For example, a general machine learning model can be downloaded from a server and trained locally to obtain a trained machine learning model. Machine learning models can include anomaly detection models and fault diagnosis models. The abnormal diagnosis model can be used to determine whether the stamping machine has a fault, and the fault diagnosis model can be used to determine the type of the fault of the stamping machine. In some embodiments, the general anomaly detection model and the general fault diagnosis model downloaded from the server may correspond to the normal working conditions of the stamping machine. In some embodiments, the general anomaly detection model and the general fault diagnosis model downloaded from the server may correspond to one or more of specific processing working conditions in normal processing working conditions. The general anomaly detection model and the general fault diagnosis model can be trained using the features obtained at step S204 to obtain and store the trained anomaly detection model and the trained fault diagnosis model.

In one embodiment, the anomaly detection model may include a distribution-based machine learning method (such as 3sigma, Z-score, boxplot, etc.), a distance-based machine learning method (such as K nearest neighbor (KNN)), a density-based machine learning method (such as Local Outlier Factor, LOF), connectivity-based outlier factor (COF), Stochastic Outlier Selection (SOS), etc.), clustering-based machine learning methods (such as, Density-based spatial clustering of applications with noise (DBSCAN), etc., tree-based machine learning methods (such as Isolation Forest, iForest, etc.), dimensionality-based machine learning methods (such as, Principal Component Analysis (PCA), AutoEncoder, etc.), classification-based machine learning methods (such as One-Class SVM, etc.), prediction-based machine learning methods (such as, Moving Average, autoregressive integrated moving average model (ARIMA), etc.). Although the example embodiment shows some anomaly detection models using machine learning, those skilled in the art should understand that the above description is only exemplary and not exhaustive, and other models for anomaly detection existing or developed in the future can be used to determine whether the stamping machine fails, all of which are within the expectation of this disclosure.

In one embodiment, the fault diagnosis model may include decision tree, Random Forest, Logistic regression, Naive Bayes, etc. Although the example embodiment shows some fault diagnosis models using machine learning, it should be understood by those skilled in the art that the above description is only exemplary and not exhaustive, and other models for fault diagnosis existing or developed in the future can be used to determine the types of faults occurring in the stamping machine, all of which are within the contemplation of this disclosure.

Generally, the training of anomaly detection model and fault diagnosis model requires a lot of training data and takes up a lot of computing resources including CPU and RAM, and the training process is very long, for example, the training process may reach several days. In the embodiment of the present disclosure, the general anomaly detection model and the general fault diagnosis model can be trained by using vibration data and rotational speed data in a boosting manner. Boosting algorithm can generate a weak learner based on the training samples, and then adjust the sample distribution according to the performance of the weak learner, that is, increase the weight of the wrong samples, so that it will attract more attention in the future. After adjusting the weight of the training set, continue to generate a new weak learner, and continue to cycle this process until a certain number of weak learners are generated. Finally, the outputs of these weak learners are synthesized based on the combination strategy. By using boosting algorithm, the training time of anomaly detection model and fault diagnosis model can be shortened to several hours, such as 4 hours.

The trained machine learning model can be used to perform the health assessment of stamping machine bearings. For example, a trained anomaly detection model can be used to determine whether a stamping machine has a fault, and a trained fault diagnosis model can be used to determine the type of fault that the stamping machine has. The health assessment of the stamping machine bearing can be performed every predetermined time period (for example, every hour). Every time a health assessment is performed, the health assessment can be performed on the bearing of the stamping machine based on the average value of vibration data and rotational speed data of the bearing collected during a plurality of collection periods in 24 hours before the time point of health assessment. For example, vibration data and rotational speed data of bearings can be collected every half hour in an collection period such as 1 minute. In this way, the influence of sudden changes in some data can be avoided. By collecting rolling historical data to generate statistical results, the false alarm rate can be effectively avoided. In one embodiment, abnormality detection can be performed based on rolling history data, and bearing health assessment scores based on abnormality detection results can be displayed. When the health assessment score is lower than the threshold, fault diagnosis can be further performed.

FIG. 5 is an exemplary schematic diagram of a generated health assessment score according to an embodiment of the present disclosure.

As shown in FIG. 5, the health of bearings can be continuously evaluated for 2000 hours. By displaying the health assessment scores of bearings to users in real time, users can fully understand the health degree of bearings, and then prepare for maintenance and other activities in advance when necessary.

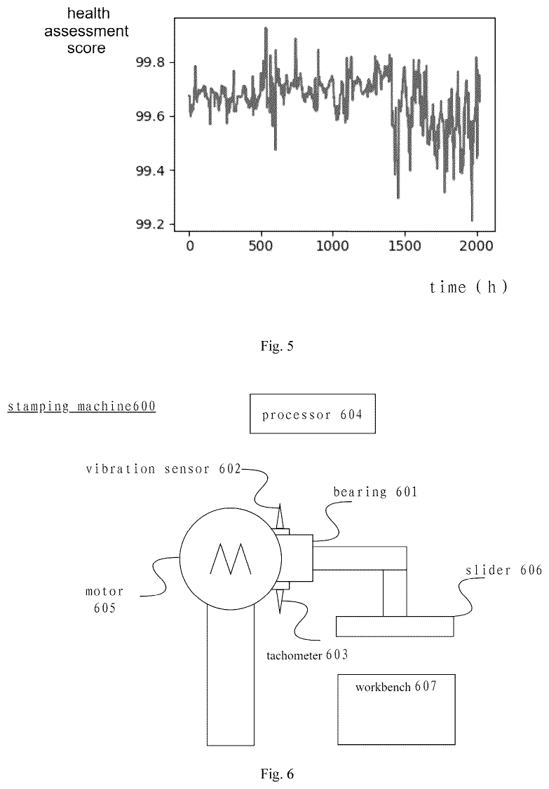

FIG. 6 is an exemplary schematic diagram of a stamping machine according to an embodiment of the present disclosure.

As shown in FIG. 6, the stamping machine 600 may include a bearing 601, a vibration sensor 602, a tachometer 603, a processor 604, a motor 605, a slider 606 and a workbench 607.

The bearing 601 can be configured to support the transmission mechanism, so as to transmit power from the motor 605 to the slider 606 through the transmission mechanism, so that the slider 606 can perform stamping action to cooperate with the workbench 607 to process the workpiece.

The vibration sensor 602 may be installed at the support of the bearing 601 and configured to obtain vibration data of the bearing. The vibration sensor 602 may include, but is not limited to, a mechanical vibration sensor, an optical vibration sensor and an electrical vibration sensor (such as an inductive vibration sensor, an eddy current vibration sensor, a capacitive vibration sensor, a resistance strain vibration sensor and a piezoelectric vibration sensor).

The tachometer 603 may be installed at the support of the bearing 602 and configured to obtain rotational speed data of the bearing. The tachometer 603 may include, but is not limited to, a centrifugal tachometer, a magnetic tachometer, an electric tachometer, a magnetoelectric tachometer, and a flash tachometer.

The processor 604 may be coupled to the vibration sensor 602 and the tachometer 603. For example, the processor 604 can be coupled to the vibration sensor 602 and the tachometer 603 through cables or wireless connections. The connection part in the form of cable connection may include cables for transmitting analog signals (for example, voltage and 4-20 mA current) or digital signals (pulse, CAN, RS485, etc.). The connection part in the form of cable is more suitable for applications that need high performance acquisition and high reliability. The connection part in the form of wireless connection may include various configurations and protocols, including short-range communication protocols such as Bluetooth™ and Bluetooth™ MLE, sub GHz, wireless HART, infrared link, ZigBee, Radio Frequency Identification (RFID), WiFi, Internet, World Wide Web, Intranet, virtual private network, wide area network, local area network, private network using communication protocols exclusive to one or more companies, Ethernet and HTTP, and combination of above. The connection part in the form of wireless connection is more suitable for the requirements of easy installation and small size. The processor 604 may execute the program code stored in the memory to perform health assessment on the bearing of the stamping machine based on the vibration data and the rotational speed data of the bearing of the stamping machine.

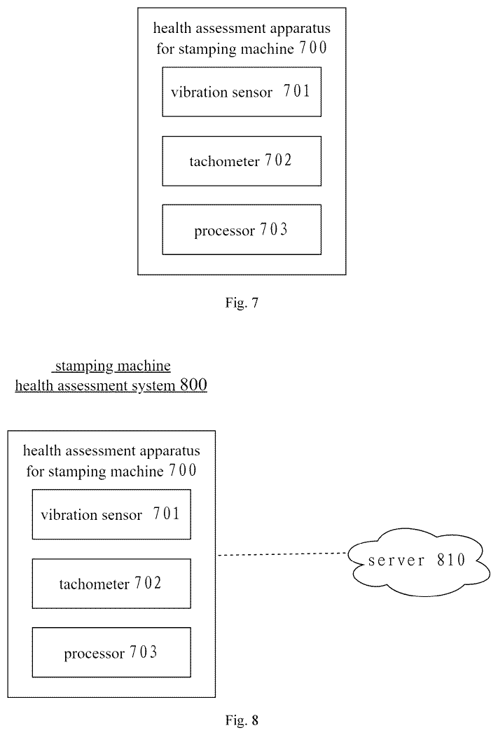

FIG. 7 is an exemplary schematic diagram of a health assessment device for a stamping machine according to an embodiment of the present disclosure.

As shown in FIG. 7, the health assessment apparatus 700 for stamping machine may include a vibration sensor 701, a tachometer 702, and a processor 703. Descriptions of the same elements in FIG. 7 as in FIG. 6 are not repeated.

The vibration sensor 701 may be installed at the bearing support of the stamping machine and may be configured to obtain vibration data of the bearing of the stamping machine.

The tachometer 702 may be installed at the bearing support of the stamping machine and may be configured to obtain the rotational speed data of the bearing of the stamping machine.

The processor 703 can be coupled to the vibration sensor 701 and the tachometer 702, and can be configured to perform the health assessment of the stamping machine bearing based on the vibration data and the rotational speed data of the stamping machine bearing.

FIG. 8 is an exemplary schematic diagram of a health assessment system of a stamping machine according to an embodiment of the present disclosure.

As shown in FIG. 8, the stamping machine health assessment system 800 may include a stamping machine health assessment apparatus 700 and a server 810. Descriptions of the same elements in FIG. 8 as in FIG. 7 are not repeated.

The server 810 may be configured to store a general anomaly detection model and a general fault diagnosis model.

The health assessment apparatus 700 of the stamping machine may include a vibration sensor 701, a tachometer 702, and a processor 703.

The vibration sensor 701 may be installed at the bearing support of the stamping machine and may be configured to obtain vibration data of the bearing of the stamping machine.

The tachometer 702 may be installed at the bearing support of the stamping machine and may be configured to obtain the rotational speed data of the bearing of the stamping machine.

The processor 703 may be coupled to the vibration sensor 701 and the tachometer 702, and may be configured to download (e.g., through a communication module) a general anomaly detection model and a general fault diagnosis model from a server. The processor 703 can train the general anomaly detection model and the general fault diagnosis model locally to obtain the trained anomaly detection model and the trained fault diagnosis model, and then perform a health assessment on the bearing of the stamping machine based on the vibration data and rotational speed data of the bearing using the trained anomaly detection model and the trained fault diagnosis model.

The connection between the health assessment apparatus 700 of the stamping machine and the server 810 may be via the communication module of the health assessment apparatus 700 of the stamping machine and/or various configurations and protocols. The communication module can use various cellular communication technologies, such as GSM, CDMA, UMTS, EV-DO, WiMAX, LTE or 5th generation “5G” cellular technology and other cellular technology developed in the future. Various configurations and protocols include short-range communication protocols, such as Bluetooth™, Bluetooth™ MLE, sub GHz, wireless HART, infrared link, ZigBee, Radio Frequency Identification (RFID), WiFi, Internet, World Wide Web, Intranet, Virtual Private Network, Wide Area Network, Local Area Network, private network using communication protocols exclusive to one or more companies, Ethernet and HTTP, and various combinations of the foregoing.

As can be understood by those skilled in the art, the health assessment apparatus 700 for stamping machine in FIG. 8 can be replaced by the stamping machine 600 without departing from the scope of the present disclosure.

Although a memory is not shown in FIGS. 6-8, one of ordinary skill in the art will understand that a processor may include one or more memories having instructions and/or data stored thereon. In addition, although FIGS. 6-8 functionally show the processor and the sensor as being in a single box, those skilled in the art will understand that the processor and the sensor may actually include a plurality of processors and a plurality of sensors of the same type, which may or may not be stored in the same physical housing. Therefore, references to processors or sensors will be understood to include references to a set of processors operating in parallel or not and a set of sensors of the same type.

The embodiment of the disclosure provides a computer-readable storage medium, and computer instructions are stored on the computer-readable storage medium, and when executed by a processor, the computer instructions cause the processor to execute the health assessment method of a stamping machine according to the embodiment of the present disclosure.

Computer-readable storage media for providing program codes include floppy disks, hard disks, magneto-optical disks, optical disks (such as CD-ROM, CD-R, CD-RW, DVD-ROM, DVD-RAM, DVD-RW), magnetic tapes, nonvolatile memory cards and ROMs.

Alternatively, the program code can be downloaded from the server computer by the communication network.

According to the health assessment method, the stamping machine, the health assessment apparatus for stamping machine, the health assessment system for stamping machine and the storage medium of the embodiment of the present disclosure, accurate and timely health assessment of the stamping machine can be performed locally based on vibration data and rotational speed data of bearings. Through real-time or near-real-time health assessment for stamping machines, the performance degradation or failure of stamping machines can be found in time, thus reducing the probability of unexpected shutdown and potential losses. By preprocessing vibration data and rotational speed data, more accurate and valid data can be obtained, which makes the health assessment for stamping machines more accurate. The machine learning model downloaded locally is used to evaluate the health of the stamping machine, and the processing data of the stamping machine does not need to be uploaded to the server or the cloud, so the data security is guaranteed.

The text and drawings are provided as examples only to help understand the present disclosure. They should not be construed as limiting the scope of the present disclosure in any way. Although certain embodiments and examples have been provided, based on the disclosure herein, it is clear to those skilled in the art that changes can be made to the illustrated embodiments and examples without departing from the scope of this disclosure.

Although the present disclosure has been described with exemplary embodiments, various changes and modifications can be suggested to those skilled in the art. This disclosure is intended to cover such changes and modifications as fall within the scope of the appended claims.

Any description in the present disclosure should not be understood as implying that any particular element, step or function is an essential element that must be included within the scope of the claims. The scope of the patent subject matter is limited only by the claims.

What is claimed is:

1. A health assessment method for a stamping machine, the method comprising:
obtaining vibration data of a bearing of the stamping machine,
obtaining the rotational speed data of the bearing of the stamping machine, and
based on the vibration data and the rotational speed data of the bearing of the stamping machine, performing the health assessment on the bearing of the stamping machine.

2. The method according to claim 1, wherein,
obtaining the vibration data of the bearing of the stamping machine through the vibration sensor installed at the support of the bearing of the stamping machine, and
obtaining the rotational speed data of the bearing of the stamping machine through the tachometer installed at the support of the bearing of the stamping machine.

3. The method according to claim 1, further comprising: extracting valid data from the vibration data and the rotational speed data, wherein the valid data extraction comprises:
obtaining vibration data and rotational speed data of a target working condition in a plurality of working conditions.

4. The method according to claim 3, wherein the plurality of working conditions correspond to different processing speed ranges of the stamping machine.

5. The method according to claim 3, wherein the valid data extraction further comprises:
filtering external disturbance signals from vibration data and rotational speed data of a target working condition to obtain filtered vibration data and filtered rotational speed data, wherein the external disturbance signals comprise stamping signals in machining process of the stamping machine, and
removing outliers from the filtered vibration data and the filtered rotational speed data.

6. The method according to claim 1, wherein the vibration data comprises acceleration data, and performing the health assessment of the bearing of the stamping machine based on the vibration data and the rotational speed data comprises:
obtaining one or more of frequency spectrum data of acceleration data, velocity data and frequency spectrum data of velocity data, envelope data of acceleration and frequency spectrum data of envelope data of acceleration by data conversion of vibration data.

7. The method according to claim 6, wherein performing the health assessment of the bearing of the stamping machine based on the vibration data and the rotational speed data further comprises:
obtaining one or more of bearing rotation frequency and its harmonics, gear meshing frequency and its harmonics, bearing failure frequency and its harmonics by feature extraction of acceleration data, frequency spectrum data of acceleration data, velocity data and frequency spectrum data of velocity data, envelope data of acceleration and frequency spectrum data of envelope data of acceleration.

8. The method according to claim 1, wherein performing the health assessment of the bearing of the stamping machine based on the vibration data and the rotation speed data comprises performing the health assessment of the bearing of the stamping machine through the trained abnormality detection model and the trained fault diagnosis model,
wherein the trained anomaly detection model is configured to determine whether a fault occurs in the stamping machine, and
wherein, the trained fault diagnosis model is configured to determine the types of faults occurring in the stamping machine.

9. The method of claim 8, further comprising:
downloading a general anomaly detection model from a server, training the general anomaly detection model locally to obtain the trained anomaly detection model, and
download the general fault diagnosis model from the server and train the general fault diagnosis model locally to obtain the trained fault diagnosis model.

10. A stamping machine comprising:
a bearing configured to support the transmission mechanism to transmit power from the motor to the slider through the transmission mechanism, so that the slider performs a stamping action,
a vibration sensor installed at a support of the bearing and configured to obtain vibration data of the bearing,
a tachometer installed at the support of the bearing and configured to obtain rotational speed data of the bearing, and
a processor coupled to the vibration sensor and the tachometer, and executing the program code stored in the memory to perform the health assessment on the bearing of the stamping machine based on the vibration data and the rotational speed data of the bearing of the stamping machine.
